(19) United States
(12) Patent Application Publication
(10) Pub. No.: US 2026/0281492 A1
(43) Pub. Date: Sep. 17, 2026

(54) SYNCHRONIZING AUDIOVISUAL STREAMS DELIVERED THROUGH SEPARATE DELIVERY NETWORKS

(71) Applicant: Infrared5, Inc., Jamaica Plain, MA (US)

(72) Inventors: Christopher Allen, Boston, MA (US); Mark Pace, Santa Cruz, CA (US)

(21) Appl. No.: 19/683,069

(22) Filed: May 20, 2026

Related U.S. Application Data
(63) Continuation of application No. PCT/US2024/058030, filed on Dec. 2, 2024.
(60) Provisional application No. 63/605,334, filed on Dec. 1, 2023.

(51) Int. Cl. H04N 21/43; H04N 21/41; H04N 21/422; H04N 21/439; H04N 21/462; H04N 21/482

(52) U.S. Cl. CPC H04N 21/43072; H04N 21/4112; H04N 21/42203; H04N 21/4394; H04N 21/462; H04N 21/482

(57) ABSTRACT

A subscriber device connected to a delivery system for live interactive programming, is at a point of delivery of both live interactive content and broadcasted live video programming. The subscriber device receives the live interactive programming from the live interactive delivery system, and presents such programming on presentation devices. Other presentation devices at the point of delivery present the broadcasted video programming. The subscriber device captures audible sound from the environment at the point of delivery. An application compares the captured sound to the audio from the live interactive programming to determine any delay between the live interactive programming and the broadcast video programming. Given the determined delay, the determined delay can be used to synchronize presentation of live interactive programming by the subscriber device with the broadcasted video programming.

### CROSS-REFERENCE TO RELATED APPLICATIONS

This application is a continuation application claiming priority to, and the benefit of, prior filed PCT Patent Application Ser. No. PCT/US2024/058030, entitled "SYNCHRONIZING AUDIOVISUAL STREAMS DELIVERED THROUGH SEPARATE DELIVERY NETWORKS," filed December 2, 2024, which in turn claims priority to U.S. Provisional Patent Application Serial Number 63/605,334, filed December 1, 2023, entitled "SYNCHRONIZING AUDIOVISUAL STREAMS DELIVERED THROUGH SEPARATE DELIVERY NETWORKS," which is hereby incorporated by reference.

### BACKGROUND

In some environments, two or more audiovisual streams are delivered to one or more devices at a point of delivery, such as a home, where the audiovisual streams are synchronized and presented. The synchronized presentation of separately delivered streams encounters technical challenges when the audiovisual streams are delivered by distinct delivery systems through distinct delivery channels.

An example of an application in which two or more audiovisual streams are presented involves delivering live streams or interactive programming, or both, through a live streaming network over the internet, and delivering video programming through a separate and distinct broadcasting system, such as cable, satellite, internet, or radio-based transmissions. In such an application, the presentation of the live stream or interactive programming over the internet is synchronized, at the point of delivery, with the presentation of the video programming over the broadcasting system. The two distinct audiovisual streams may be presented on separate devices, such as on a computer or mobile phone, on the one hand, and on a television, on the other hand.

One of the technical challenges is synchronizing the presentation of the two or more audiovisual streams. Another technical challenge is simultaneously minimizing latency of the delivery of the two or more audiovisual streams.

Some delivery systems address these problems by injecting high frequency, inaudible signals into one of the streams, such as into an audio channel of broadcasted audiovisual programming. However, this solution is not feasible if one delivery system does not have permission or access to inject such signals into the content delivered by the other delivery system. In some cases, injecting such a signal involves additional technical infrastructure, effort, and cost, which may be undesirable.

### SUMMARY

This Summary introduces a selection of concepts in simplified form that are described further below in the Detailed Description. This Summary neither identifies key or essential features, nor limits the scope, of the claimed subject matter.

A subscriber device is connected to a first delivery system for a first audiovisual stream, such as a live streaming system that delivers one or more live or interactive audiovisual streams, or combination of these. A second audiovisual stream, such as a broadcasted live audiovisual program, is delivered by a distinct delivery system, such as a broadcast television network. The first delivery system does not inject a signal into the second audiovisual stream delivered by the second delivery system, as it may not have permission or access to do so, or it may be simply undesirable to do so for a variety of reasons. The subscriber device is at a geographical location which is a point of delivery of both the first and second audiovisual streams. The subscriber device receives the first audiovisual stream from the first delivery system, and presents such programming on presentation devices, such as a display and speakers or headphones, on or connected to the subscriber device. One or more presentation devices at the point of delivery, such as a television with a display and sound system, receive and present the second audiovisual stream received through the second delivery system. These presentation devices can be part of or separate from the presentation devices on or connected to the subscriber device.

In this context, to address the issues of synchronization and latency, the subscriber device has a microphone and an application running on the subscriber device that captures and processes audio signals from the microphone. The application configures the subscriber device to use the microphone to capture sound from the environment at the point of delivery. Such sounds include any audible signal of the second audiovisual stream being presented through a presentation device in the environment at the point of delivery.

A component running on a computer device, which may be a device within the first delivery system, processes sound captured by the application and compares that sound to reference audio data to determine any delay between sound presented based on the second audiovisual stream and the reference audio data. The reference audio data is provided to the first delivery system by the second delivery system. Given the determined delay, the determined delay is used to cause the subscriber device to synchronize presentation of the first audiovisual stream delivered by the first delivery system to presentation of the second audio visual stream. There are several ways in which the determined delay can be used to effect such synchronization.

There are several applications in which such techniques can be used.

The first delivery system can be a live streaming system that delivers live or interactive content, or both, to a subscriber device. The delivered content is intended to be presented by the subscriber device in synchronization with live content delivered through a broadcast television network (the second delivery system). For example, the broadcast television network may be broadcasting a live sporting event, such as a soccer (football), American football, basketball, hockey, baseball, or other event. The live streaming system does not insert a synchronizing signal into the live content delivered by the broadcast television network. The live streaming system may be delivering, for example, live audiovisual content from other sources, such as spectators’ mobile devices or other cameras. The live audiovisual content can be from locations other than the sporting event. The live streaming system may be delivering interactive content, such as hyperlinks to access digital content related to the broadcasted live content, or graphics or other information related to the broadcasted live content. The determined delay is used to synchronize presentation of the two streams of content.

The first delivery system can be a virtual reality system, such as a gaming system that delivers sound and rendered images for a virtual environment to a subscriber device. The sound and rendered images are intended to be presented by the subscriber device in synchronization with live content delivered through a broadcast television network (the second delivery system). The live streaming system may be delivering, for example, game update instructions based on interactive game play by multiple remote users, to the subscriber device. The determined delay is used to synchronize presentation of the two streams of content.

In some implementations, a component of the first delivery system on the subscriber device receives both the captured audio from the application on the subscriber device and the reference audio data. This component computes the delay between the two streams. This component may be part of the application on the subscriber device or may be a separate application on the subscriber device. In some implementations, the application on the subscriber device which captures the audio from the environment of the point of delivery also receives the reference audio data. This component computes the delay between the two streams.

In some implementations, the application or the component on the subscriber device uses the determined delay for synchronization. In some implementations, the application or the component on the subscriber device transmits the determined delay to an edge device in the first delivery system for the edge device to use in synchronization.

In some implementations, the application, or a component of the first delivery system on the subscriber device transmits the captured audio to a device of the first delivery system. The device receives both the captured audio from the application on the subscriber device and the reference audio data. The device then computes the delay between the two streams. The device of the first delivery system can be an edge device or any other device of the first delivery system which can receive both the captured audio from the application on the subscriber device and the reference audio data and which can deliver data representing the determined delay to another device to perform synchronization.

In some implementations, a device in the first delivery system delays delivery of the first audiovisual stream to the subscriber device based on the determined delay. In some implementations the device is an edge device. In some implementations, the device is another device of the first delivery system involved in the delivery of the first audiovisual stream. In some implementations a component of the first delivery system on the subscriber device or the application on the subscriber device delays presentation of the first audiovisual stream by the subscriber device based on the determined delay. In some implementations, a device in the first delivery system, such as an edge device or other device, delays rendering of data for the first audiovisual stream based on the determined delay. In some implementations a component of the first delivery system on the subscriber device or the application on the subscriber device delays rendering of data for the first audiovisual stream by the subscriber device based on the determined delay.

Accordingly, in one aspect, the system includes a subscriber device that receives first media data from a first delivery system and presents it in synchronization with second audiovisual data from a second delivery system in the subscriber device's environment. An application on the subscriber device captures audio signals from the environment via a microphone. A component compares the captured audio to reference audio data from the second delivery system to determine any delay. The system then delays presentation of the first media data according to the determined delay to synchronize it with the second audiovisual data.

In one aspect, a system includes means for capturing audio signals from an environment and means for comparing the captured audio signals to reference audio data to determine a delay. The system includes means for delaying presentation of first media data on a presentation device according to the determined delay to synchronize presentation of the first media data with second audiovisual data.

In one aspect, a process for synchronizing presentation of media data from multiple sources includes capturing audio signals representing ambient sound in an environment and computing a delay between the captured audio signals and reference audio. The process includes adjusting timing of presentation of the media data based on the determined delay.

In one aspect, a system includes multiple subscriber devices that each receive first media data from a first delivery system and present, in their respective environments, the first media data in synchronization with second audiovisual data from a second delivery system. Each subscriber device runs an application to capture audio signals representing ambient sounds in their local environments. For each subscriber device, a component determines a delay between the captured audio signals and reference audio data. The first delivery system includes at least one edge device with connections to the subscriber devices. This edge device has a buffer for the first media data and a data transfer controller that uses the determined delays to individually delay transmission of the first media data to each subscriber device.

In one aspect, a system includes means for capturing audio signals from multiple environments and means for determining respective delays for each environment between each audio signal and reference audio data. The system includes a buffer for storing first media data, and controlling transfer of the first media data from the buffer to devices in the multiple environments based on the respective determined delays for those environments.

In one aspect, a process for synchronizing presentation of media data across multiple devices includes capturing audio signals representing ambient sound at each device location. A respective delay between each audio signal and reference audio data is computed for each device. The media data is stored in a buffer. Transmission of the media data from the buffer to each device is controlled based on the respective delay computed for that device.

In some implementations, the system includes one or more of the following features. Delaying presentation of the first media data includes delaying transmission of the first media data to the subscriber device. Delaying presentation of the first media data includes delaying transmission of the first media data to a presentation device by the subscriber device. Delaying presentation of the first media data includes delaying rendering of media data based on the first media data.

In some implementations, the first media data includes a plurality of media streams. Each subscriber device allows an end user to select from among the plurality of media streams. The system sends the respective selected media streams to each subscriber device based on the determined delays for each subscriber device.

Any of the foregoing aspects may be embodied as a computer system, as any individual component of such a computer system, as a process performed by such a computer system or any individual component of such a computer system, or as an article of manufacture including computer storage in which computer program code is stored and which, when processed by the processing system(s) of one or more computers, configures the processing system(s) of the one or more computers to provide such a computer system or individual component of such a computer system.

The following Detailed Description references the accompanying drawings which form a part of this application, and which show, by way of illustration, specific example implementations. Other implementations may be made without departing from the scope of the disclosure.

### BRIEF DESCRIPTION OF THE DRAWINGS

FIG. 1 is an architecture diagram of an example implementation a system that includes delivery systems for live interactive programming and broadcast video programming.

FIG. 2 is a data flow diagram of an example implementation of an application for synchronizing delivery of content by a subscriber device to broadcast programming.

FIG. 3 is a flow chart of an example implementation of a process implemented by the delivery system for live interactive programming.

FIGS. 4A-4C show example synchronization techniques.

FIG. 5 is a block diagram of an example general-purpose computer.

### DETAILED DESCRIPTION

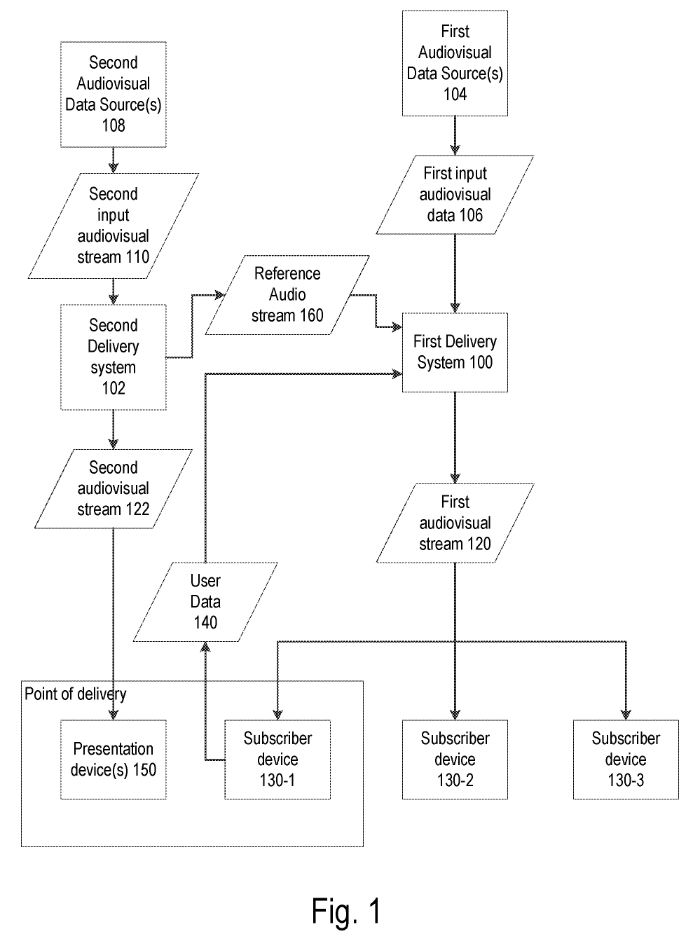

Referring now to FIG. 1, an example environment for using the techniques explained herein will now be described. One or more subscriber devices 130-1, 130-2, 130-3, and so on, (each individually a “subscriber device 130”), are connected to a first delivery system 100 to receive a first audiovisual stream 120. The first audiovisual stream typically includes at least live audiovisual data. A second audiovisual stream 122, such as a broadcast live audiovisual program, is delivered by a second delivery system 102, such as a broadcast television network, which is separate and distinct from the first delivery system 100. The first delivery system 100 does not inject a signal into the second audiovisual stream 122 delivered by the second delivery system 102. However, the first delivery system 100 does receive a reference audio stream 160 from the second delivery system 102 corresponding to audio to be played back by presentation devices 150 after receiving the second audio visual stream 122.

Each subscriber device 130 is at its own respective geographical location, which is a point of delivery of both the first and second audiovisual streams. A subscriber device 130 receives the first audiovisual stream 120 from the first delivery system 100 and presents such programming on its respective presentation devices (not shown), such as a display and speakers or headphones, on or connected to the subscriber device. For example, the subscriber device may be a mobile phone, tablet computer, laptop computer, desktop computer, gaming console, or smart television. One or more presentation devices 150 at the point of delivery, such as a television with a display and sound system, receive and present the second audiovisual stream 122 received through the second delivery system 102. These presentation devices 150 which present the second audiovisual stream 122 can be part of or separate from the presentation devices on or connected to the subscriber device 130.

For each audiovisual stream 120 provided by the first delivery system 100, a first audiovisual data source 104 provides first input audiovisual data 106 to the first delivery system 100. Similarly, for each stream of audiovisual data provided by the second delivery system 102, second audiovisual data source(s) 108 provide second input audiovisual data 110 to the second delivery system 102. Typically, a delivery system includes an encoder which optionally embeds additional content into and formats the input audiovisual stream into the audiovisual stream to be delivered by the delivery system.

In an example implementation described herein, both the first delivery system and the second delivery system provide live audiovisual programming. Live programming typically includes one or more streams of audiovisual data and other related data, such as audio, images, text, graphics, or any other media data. Live programming can include sound and rendered images for a virtual environment. The first delivery system may be delivering, for example, game update instructions based on interactive game play by multiple remote users, which is then rendered to produce sound and rendered image for the virtual environment.

The live programming can include interactive content. In the context of interactive content, user data 140 from the subscriber device 130 is transmitted to the first delivery system 100 by the subscriber device. The first delivery system 100 can receive a variety of user data 140 from subscriber devices 130. Such data can include data related to a viewer, input from a viewer, criteria related to the content, or other criteria, or any combination of these. Criteria related to the viewer can include but are not limited to a viewer’s location or a viewer’s personal data. Criteria related to the content can include but are not limited to content insertion metadata or data extracted from the content, such as static areas or watermarks.

The first delivery system can be implemented using a live streaming cluster. The live streaming cluster can be deployed as a cluster architecture that supports many subscriber devices and broadcaster devices while providing a live video streaming experience with an end-to-end latency below 500 milliseconds (ms). The live streaming cluster typically includes one or more devices (also called “nodes”), such as origin devices, optional relay devices, and edge devices. The edge devices in the live streaming cluster ultimately produce a separate and distinct live feed for each viewer, which is delivered to respective subscriber devices 130 for the viewers. Each edge device can insert and deliver content to each of its respective subscriber devices, which content is different from the content that other edge devices deliver to their respective subscriber devices.

The cluster architecture, in some embodiments, can be implemented on a cloud-based infrastructure (such as a set of servers provided by a service such as Amazon Web Services (AWS) or Microsoft Azure) using a set of compute instances that include stream managers devices, origin devices, relay devices, and edge devices, also called subscriber devices, that are deployed on the cloud infrastructure. The cluster architecture can be implemented using technologies other than a cloud-based cluster. A content delivery network (CDN), a decentralized network, or other collection of server computers accessible over a computer network can be used. In the example of a cloud infrastructure, for example, such a deployment can be controlled by the content providers or can be provided as a service to content providers.

In some implementations, the cluster architecture includes a set of clusters that are deployed in different geographic regions to serve computer network traffic coming from anywhere, while providing low latency delivery of the video streams. Example implementations of such a cluster architecture are described in U.S. Patents 8019878, 8024469, 8171145, 8166181, and 8019867, and U.S. Published Patent Applications 2019/0320004, 2019/0320014, and 2019/0028465, all of which are hereby incorporated by reference.

This system can be used to deliver a variety of kinds of audiovisual programming. For example, the second delivery system can be a conventional television broadcasting system that provides live audiovisual programming. The first delivery system may receive and distribute a second live audiovisual stream, which may include video from different camera angles within the same venue or video from different locations. In some implementations, the video may originate from a subscriber device.

The second audiovisual stream may be presented on various types of displays or presentation devices beyond traditional televisions. In some cases, the presentation devices may include large-scale theater displays, digital billboards, or digital signs in public spaces. The second audiovisual stream may be displayed on multiple screens, such as in a sports bar setting that allows patrons to view content captured from different camera angles simultaneously. In some implementations, the presentation devices may include advanced display technologies, such as a large sphere of programmable LEDs, such as the Las Vegas SPHERE, which offers immersive 360-degree viewing experiences. The locations for presentation devices may vary widely, from indoor venues like movie theaters and convention centers to outdoor spaces such as stadiums, arenas, or city squares. In some implementations, the second audiovisual stream is presented on synchronized displays across multiple points of delivery for geographically dispersed audiences. In some implementations, the presentation device includes a 3D rendering system. Such a rendering system can create a virtual environment representing a live event occurring at a remote location.

The second delivery system may utilize various methods for delivering the second audiovisual stream beyond traditional broadcast television. In some implementations, the second delivery system may employ cable networks which use a combination of fiber optic and coaxial cables to deliver audio and video to set-top boxes, smart televisions, or other computing devices. In some implementations, the second delivery system can include satellite delivery of signals which are received by satellite dishes which in turn deliver signals to presentation devices. In some cases, the second delivery system may mirror the architecture of the first delivery system, utilizing a cluster-based infrastructure with origin, relay, and edge devices to manage and distribute content. In some implementations, the second delivery system may implement content delivery network (CDN) technologies, distributing audiovisual data across multiple servers to optimize delivery speed and reliability. In some implementations, the system may utilize internet protocol television (IPTV) methods, delivering content through managed networks using protocols like HTTP Live Streaming (HLS) or Dynamic Adaptive Streaming over HTTP (DASH). With any such second delivery system, these techniques enable the first delivery system to present the first audiovisual stream in synchronization with audiovisual streams delivered by the second delivery system.

The following sections describe in greater detail the synchronization of the first and second audiovisual streams at a point of delivery. Generally, a delay of the second audiovisual stream with respect to the first audiovisual stream is determined. Based on this determined delay, presentation, delivery, or rendering of the first audiovisual stream, or any combination of these, can be performed.

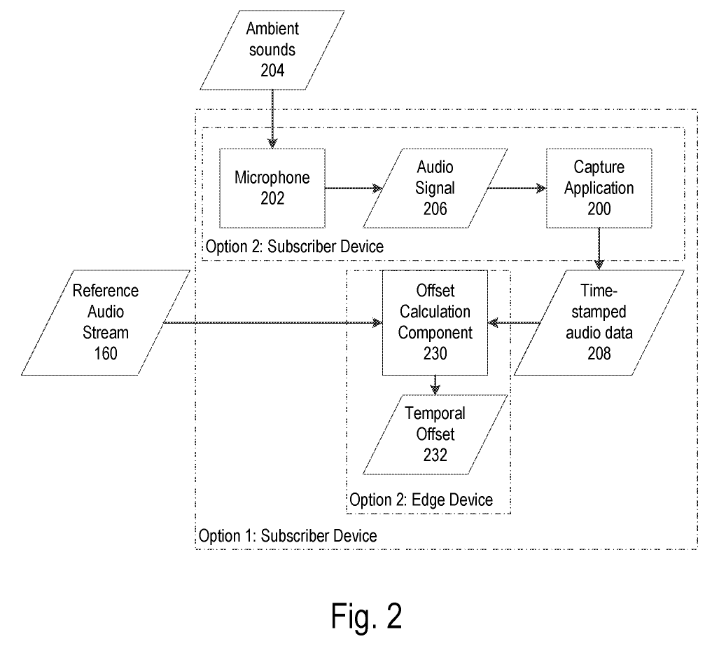

FIG. 2 is a data flow diagram of an example implementation of determining a delay between the second audiovisual stream delivered by a second delivery system and a first audiovisual stream delivered by a first delivery system. In this example, it is assumed that the first delivery system is a form of live streaming cluster which can deliver a live audiovisual stream with 500ms latency. It is further assumed that the second delivery system is a conventional television broadcasting system (whether using radio transmission, satellite transmission or other form of higher latency internet-based streaming).

In this example implementation, it is assumed that the subscriber device, which presents the first audiovisual stream, is physically co-located with one or more presentation devices (e.g., 150 in FIG. 1) which are presenting the second audiovisual stream received from the second delivery system. The subscriber device includes a media player application (not shown) that configures the subscriber device to present the first audiovisual stream through its presentation devices (not shown in FIG. 2).

The subscriber device (e.g., 130 in FIG. 1) has a microphone 202 or other form of sensor which can sense or react to ambient sounds 204 in the physical environment surrounding the subscriber device and generate an audio signal 206 representative of such sounds. The subscriber device also includes a capture application 200 which receives and processes the audio signal 206 to generate time-stamped audio data 208. A reference audio stream 160 (see FIG. 1) from the second delivery system and the audio data 208 captured from the microphone are both inputs to an offset calculation component 230. The offset calculation component generates data representing the temporal offset 232, representing the difference in time of arrival between audio received by the first delivery system and corresponding audio presented at the point of delivery based on the second audiovisual stream delivered by the second delivery system. This temporal offset 232 represents the determined delay between presentation of those two streams.

In some implementations, the offset calculation component can reside on the subscriber device, in which case an edge device establishes a data channel with the subscriber device, over which the edge device sends the reference audio stream 160 to the offset calculation component of the subscriber device. This example implementation is illustrated by the large, dashed box labeled “Option 1”. In some implementations, if a device other than the subscriber device effects the synchronization of the two audiovisual streams, a data channel also is established between the subscriber device and that other device to enable the subscriber device to transmit the computed temporal offset 232. In some implementations, such a data channel may be established anyway, to allow the subscriber to report what that offset is.

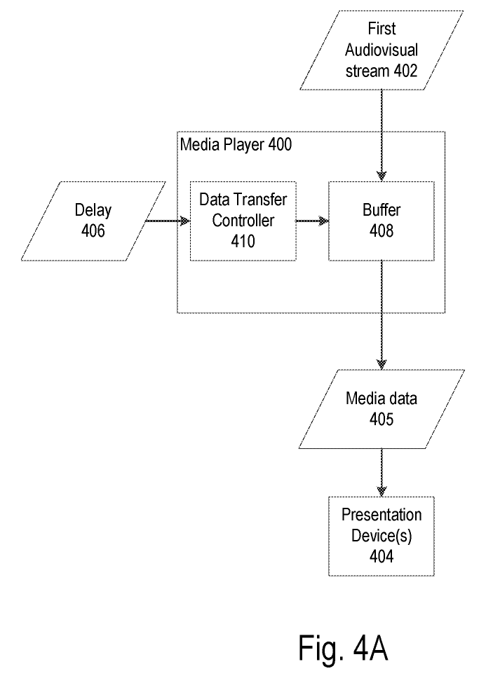

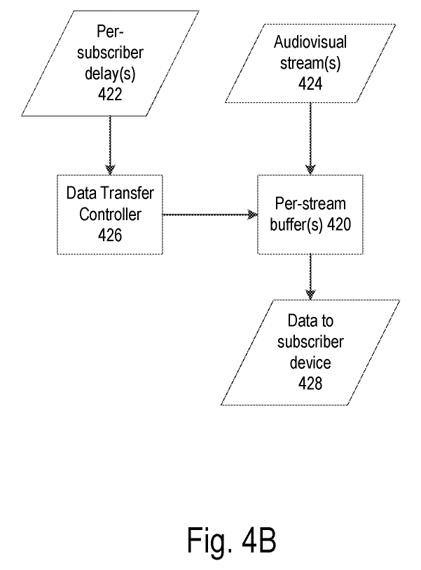

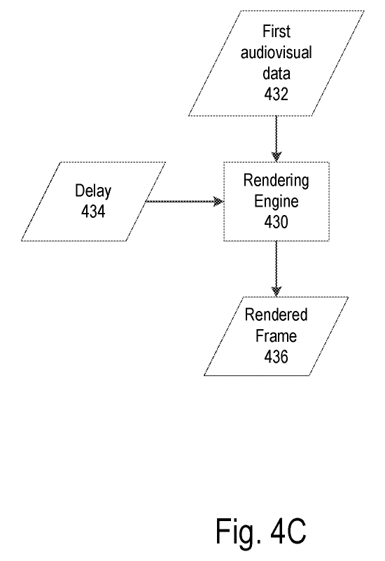

In some implementations, the offset calculation component can reside on a device of the first delivery system, such as an edge device or other computing device, in which case the subscriber device establishes a data channel with the device over which it sends the time-stamped audio data 208 to the device of the first delivery system. This example implementation is illustrated by the two smaller dashed boxes, each labeled “Option 2”. A data channel also is established between the device of the first delivery system and the device (if not the device which has the offset calculation component 230) in the system which effects the synchronization of the two audiovisual streams, to enable the device of the first delivery system to transmit the computed temporal offset 232. Such an implementation can be called a “server-side” calculation of the temporal offset 232. In some cases, the device implementing the offset calculation may have available processing cycles to perform this calculation and can provide the temporal offset 232 directly to a data transfer controller on the device that is implementing synchronization (e.g., see FIG. 4B below).

In some implementations, the offset calculation component can reside on another computing device that communicates with both the subscriber device and a device within the first delivery system. In such an implementation, a data channel is established between the subscriber device and the other computing device to enable the subscriber device to transmit the time-stamped audio data 208 to the other computing device. Also, a data channel is established between a device in the first delivery system and the other computing device to enable the device in the first delivery system to transmit the reference audio stream 160 to the other computing device. A data channel also is established between the other computing device and the device in the system which effects the synchronization of the two audiovisual streams, to enable the computing device to transmit the computed temporal offset 232.

There are several ways in which the offset calculation component 230 can compute the temporal offset 232. For example, a cross-correlation function can be used to align the audio signals, from which the offset can be determined. Note that a respective temporal offset 232 is computed for each subscriber device.

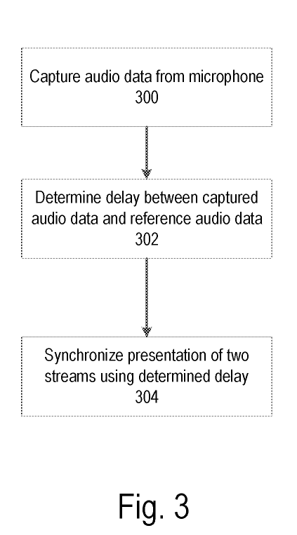

FIG. 3 shows a flow diagram of an example implementation of a process implemented by the system to synchronize two audiovisual streams. On the subscriber device, the capture application 200 captures (300) and time-stamps audio data based on the audio signal output by the microphone. The delay between the timestamped audio data and the reference audio stream accessible to the first delivery system is determined. This determination can be made by an offset calculation module (e.g., 230 FIG. 2), which may be on the subscriber device or on an edge device or on another device in the system. The determined delay is used to synchronize (304) presentation of the first audiovisual stream by the presentation device(s) for the subscriber device with presentation of the second audiovisual stream at a presentation device at the same point of delivery as the subscriber device.

In some implementations, the offset calculation component may identify from the captured audio signal 206 whether an advertisement or other content that does not include the reference audio stream 160 is being presented on the presentation devices associated with the second delivery system. During such times, the offset calculation component may suspend processing of audio signals, or may output a signal indicating that the delay (i.e., temporal offset 232) cannot be determined. A history of computed temporal offsets can be stored. The stored history can be processed to quantify a measure of any drift. By periodically re-computing the temporal offset 232, or re-computing the offset after a period in which the offset cannot be calculated, the system can react to drift or can re-synchronize.

Given the determined delay for any given subscriber device, the first audiovisual stream can be presented in synchronization with the presentation of the second audiovisual stream. FIGS. 4A-4C illustrate three example techniques for such synchronization. In these examples, the first audiovisual stream is presumed to arrive at the point of delivery with a lower latency than the second audiovisual stream, so that the first audiovisual stream is delayed to bring presentation of the two audiovisual streams into synchronization.

In FIG. 4A, a media player 400 on the subscriber device receives the first audiovisual stream 402 from the first delivery system and delivers the appropriate media data 405 to presentation devices 404 for playback. The media player 400 receives, as an input, the determined delay 406 (i.e., based on the computed temporal offset 232 in FIG. 2) and delays (e.g., with respect to the reference audio stream 160 in FIG. 1) delivery of the media data 405 to the presentation devices 404 based on the determined delay. For example, the subscriber device may have one or more caches or buffers (buffer 408) into which media data from the first audiovisual stream 402 is stored. A data transfer controller 410 sends the media data from the buffer 408 to the presentation device(s) 404 based on the delay 406.

In FIG. 4B, an edge device maintains a buffer or cache 420 for each unique stream of data delivered to subscriber devices to which the edge device has established connections. The edge device stores a respective determined delay (a per-subscriber delays 422) for each of the subscriber devices with which the edge device has established connections. For each audiovisual stream 424 received by the edge device, data from that stream is stored in an output buffer (a pre-stream buffer 420) for that stream. For each subscriber device receiving an audiovisual stream, a data transfer controller 426 uses the respective determined delay 422 for that subscriber device to control transmission of the data 428 for that audiovisual stream from the buffer 420 for that stream to that subscriber device. Such an implementation avoids having a cache or buffer for each stream for each subscriber device. Alternatively, a buffer or cache for each stream could be implemented on an edge device for each subscriber device for which the edge device has a connection. Note that with multiple edge devices, each edge device has its own cache or buffer 420 for synchronizing streams sent to the respective subscriber devices with which that edge device has connections.

In implementations such as shown in FIG. 4B, the first delivery system has at least one edge device which has respective connections established to transmit data to each subscriber device of a plurality of subscriber devices. This edge device includes a buffer for storing the first audiovisual data and a data transfer controller responsive to the respective determined delays for the plurality of subscriber devices to delay transmission of the first audiovisual data from the buffer to each subscriber device based on the respective determined delays for the subscriber devices.

In FIG. 4C, an edge device or a subscriber device may be processing a first audiovisual data 432 which includes data that is to be rendered, such as for use in a gaming engine or other virtual environment. A rendering engine 430 receives the first audiovisual data 432 to be rendered. The rendering engine 430 uses the determined delay 434 either to control when a frame is rendered, after which the rendered frame 437 is output or transmitted, or to control when the rendered frame 436 is output or transmitted (which can be held in a buffer until the designated time for output or transmission).

### Example Use Case and Additional Functions

As an example use case, the first delivery system may be a live streaming system that provides low latency live streams of video and audio from a venue, such as a stadium with a sporting event or concert. The second audiovisual stream may be broadcast video programming may be provided by one entity, such as a television station, whereas additional live streams that form the audiovisual streams delivered by the first delivery system may be provided by individuals in the venue, such as through mobile devices with cameras. For example, a synchronized multiview experience can be provided, which would enhance the at-home viewing experience of various events. Users at home then view synchronized multiview streams of an event from a live streaming cluster with the broadcast streams of the event from their local television station on respective home entertainment systems, allowing home users to enjoy views from around the event venue that are synchronized with the broadcast they are watching. At the same time, other users at the event venue can watch the multiple views in real-time with no perceivable latency.

With such a system, users, whether at home or at the event venue, have the opportunity to view multiple aspects of the event in parallel streams, while a main broadcast of the event continues, and can be viewed by users at home on their home entertainment system in synchronization with the other streams. Because the live streaming cluster supports interactivity, viewers can switch between views from around the event venue, based on cameras and other video and audio sources through the event venue. This synchronization provides the potential to view, analyze, and enjoy an event from different perspectives, all at the same moment.

For such implementations, cameras are deployed throughout the event venue to facilitate the multiview experience. These cameras are positioned to capture a wide array of perspectives, offering a comprehensive view of the event from distinct vantage points. Some example camera angles include an eagle-eye view from one or more key locations within the venue. These placements are designed to furnish an expansive perspective of the entire venue. For example, for a baseball game, cameras can be positioned above home plate, above center field, within dugouts, or behind the catcher. In some cases, users at the event venue can provide additional streams from cameras on their personal mobile devices.

The various camera feeds are incorporated as sources into the live streaming cluster. The platform coordinates the multiple feeds concurrently, ensuring smooth transmission of the distinct views. Each of these unique angles then becomes available for delivery to subscriber devices. The system allows for an interactive, viewer-driven experience where users select the desired view at their convenience.

With a simple input, such as a tap on a touchscreen, fans can cause the live streaming system to switch among the various feeds delivered to the media player on a subscriber device. This synchronized experience eliminates the delay between the local broadcast and the streams presented by the media player of the subscriber device, providing a seamless, interactive, and highly personalized viewing journey.

### Stream Switching

In some implementations, to ensure a smooth viewing experience in the application on a subscriber device a strategy of server-side switching is used. Rather than inundating the user's mobile device with multiple streams, a single stream is dispatched to the subscriber device. This approach optimizes data usage and enhances the overall performance of the application, providing users with a high-quality viewing experience. To facilitate this switching methodology a near real-time latency protocol like WebRTC or RTSP is implemented.

When a user decides to explore a different angle of an event, an interactive action as simple as a tap or a swipe prompts the subscriber device to send a command to the live streaming cluster. This request instructs the cluster to perform a rapid switch between camera views on the server-side. This server-side switching allows for the transition to be near-instantaneous, enhancing the user's experience by providing the chosen new perspective without delay and without the need for multiple streams thus drastically reducing the load on the user's mobile device.

### Synchronization

Synchronization between the first audiovisual stream on an application on a subscriber device and the second audiovisual stream from a television broadcast of a live event plays an important role in crafting an immersive viewing experience for the user. Video of a live event can be delivered to a television in multiple ways including over the air broadcast, cable delivery, and streaming. Each of these have different latencies ranging from a couple of seconds to minutes. Therefore, there is a need to synchronize with a wide variety of delay times. The synchronization of each of the audiovisual streams to a main broadcast ensures that the images and events unfolding on the television screen are mirrored simultaneously on the application, providing consistent, synchronized access to alternate angles of the live event. This integration between multiple viewing platforms is a cornerstone in creating an engaging and satisfying user experience.

As described above, two components contribute to achieving this synchronization. The first component is the offset calculation component (e.g., 232 in FIG. 2) which is designed to detect any temporal offset between the first audiovisual stream provided by the first delivery system and the second audiovisual stream as presented at the point of delivery after delivery through the second delivery system. The system provides two inputs to this component. The first input is provided by the microphone on the subscriber device, which listens to the audiovisual stream being presented on audio devices in the environment of the subscriber device. The second input is a reference audio input provided to the first delivery system from the second delivery system. The offset calculation component then analyzes this data, for example using a cross-correlation algorithm, to compute the temporal offset between the two streams. Thus, the time of arrival of the broadcast to the system versus the time of arrival of the broadcast to the point of delivery at the subscriber device is determined.

The second component is a mechanism designed to fine-tune the stream delay for each individual user. This component can reside on an edge device, or as a server-side component, which separately controls transmission of the stream to each subscriber device. Alternately, this component can reside on the subscriber device.

Using these two components accounts for variations in network latency and local broadcast timings, ensuring each user experiences a presentation in which the multiple streams are synchronized with each other.

Because insertion of content, such as advertisements or local content, may be inserted into a broadcast of a live event, such as a sporting event, typically is delivered dynamically over the broadcast, meaning that individual viewers may receive different advertisements or other locally inserted content, the cross-correlation algorithm cannot evaluate an offset during these moments. The application can alert the users during these moments to wait for the game to start in order to synchronize.

In some implementations, a manual synchronization mechanism, perhaps using a slider or other user interface component, can be used to set a default offset or an override offset. This user-controlled option would be particularly useful in scenarios where automatic synchronization could encounter challenges. For instance, in a viewing environment where the television audio is muted and only closed captions are available, the automatic synchronization using audio will not function. Another example where the automatic synchronization using audio will not work is if a user has paused the broadcast feed via a DVR and has moved out of the defined window of synchronization. A manual synchronization mechanism would allow users to adjust the timing of the multiview streams to match their local broadcast, ensuring a seamless and synchronized experience regardless of the viewing environment.

The first delivery system can be configured to monitor the offset continuously or periodically between audio presented at the point of delivery from the second delivery system and the audio of the first audiovisual stream. In some applications this offset may vary over time, due to variations in delivery by the second audiovisual stream due to, for example, network congestion, buffering events, or other factors that may affect the timing of the second audiovisual stream. By maintaining an active listening process through the microphone on the subscriber device, the system can detect changes in the latency of the second delivery system over time. This continuous monitoring allows for dynamic re-synchronization to compensate for variations in latency. In some cases, the system may detect unexpected pauses or interruptions in the second audiovisual stream, such as those caused by network issues or intentional user actions like pausing the content. When such events occur, the system may temporarily suspend synchronization efforts and resume the process once the second audiovisual stream resumes playback. Upon detecting the resumption of audio from the second audiovisual stream, the system can recalibrate the synchronization, determining a new offset between the captured audio and the reference audio stream. This adaptive approach ensures that the first audiovisual stream remains properly synchronized with the second audiovisual stream, even in the face of varying network conditions or user-initiated playback controls.

### Combined Views

The application presenting content from the live streaming cluster can, in some embodiments, generate a composite view that combines feeds from many different cameras stationed around an event venue into a collage. This collage provides users with a comprehensive overview of the event from various perspectives, all presented synchronized on a single screen. The multiplicity of views and simultaneous display creates an immersive tapestry of the event, amplifying the depth and breadth of the viewing experience. This function aligns each camera feed with the local broadcast and each other to provide a cohesive multi-angle view of the event.

In some implementations, to further enhance the user interaction with the application, each of these feeds on the composite view can be interactive. For example, a user can tap on a specific view to select that view, in response to which the application can zoom into that perspective. The user-selected view can expand to fill the screen, providing a focused, full-screen viewing experience of the chosen camera angle. As another example, users can be presented with a set of streams from which they can select which ones are placed into their collage or composite view.

These features create an environment where viewers can direct their own viewing experience, choosing which aspects of the event they want to focus on, when they want to focus on those aspects, and from which angles they want to see the event. An example implementation of such composite views is described in U.S. Patent 11,778,011 hereby incorporated by reference.

### Augmented Reality Overlays

Integrating augmented reality (AR) with a viewer’s experience can redefine the way viewers perceive an event. The introduction of AR overlays to the diverse camera views of an event further accentuates the richness of the visual content, providing an added layer of information and engagement. For example, AR can be used in sporting events to dynamically display ball trajectory or other action.

As another example, Videon EdgeCaster encoders, and other devices which support KLV metadata, can be modified accept metadata streamed via a websocket. This metadata, derived from a telemetry system, can encapsulate detailed information from an event. This metadata is then transported to subscriber devices via a WebRTC datachannel. When the data is received by the application of the subscriber device, AR overlays can be presented on the screen.

Users can do more than passively view these AR overlays. They can also interact with them. Furthermore, customization options can let users control certain aspects of their viewing experience, like adjusting the duration of comet trails remaining visible on their display.

To implement such synchronization, a computer system includes one or more computers, each processing one or more respective computer programs which instruct the respective processing system of the computer to perform various functions. Each computer typically is, but is not limited to, a kind a general-purpose computer that can be programmed to implement the functionality as described in the example implementations. Examples of a computer include, but are not limited to, a client device, including mobile devices and client computers, one or more server computers, or one or more database computers, or combinations of any two or more of these.

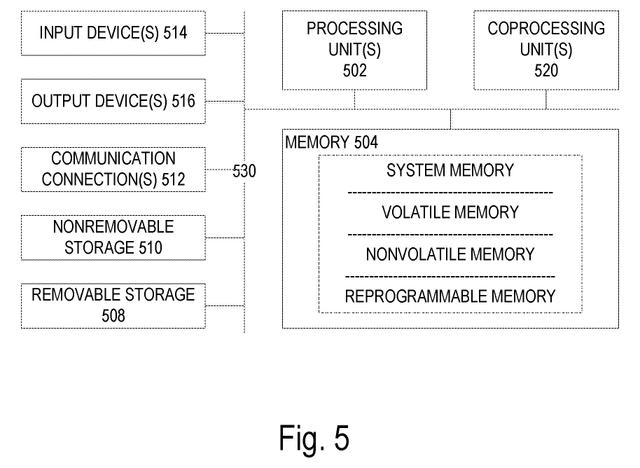

FIG. 5 is a block diagram of a computer which includes a processing system which processes computer programs. Computer programs on such a computer typically include an operating system and one or more applications. The operating system is a computer program running on the computer that manages access to resources of the computer by applications and the operating system. The resources typically include memory, storage, communication interfaces, input devices and output devices.

Examples of such computers include, but are not limited to, larger computer systems such as server computers, database computers, desktop computers, laptop and notebook computers, game consoles, as well as mobile or handheld computing devices, such as a tablet computer, handheld computer, smart phone, media player, personal data assistant, audio and/or video recorder, or wearable computing device.

With reference to FIG. 5, an example computer 500 comprises a processing system including at least one processing unit 502 and memory 504. The computer can have multiple processing units 502 and multiple devices implementing the memory 504. A processing unit 502 can include a processing core among a plurality of processing cores (not shown) within a processing device. Such processing cores typically operate independently of each other. One or more coprocessing units 520, such as a graphics processing unit or GPU or programmable logic device, also can be present in the computer. The memory 504 may include volatile devices (such as dynamic random-access memory (DRAM) or other random-access memory device), and non-volatile devices (such as a read-only memory, flash memory, and the like) or some combination of the two, and optionally including any memory available within a processing device. Other memory, such as dedicated memory or registers, also can reside within a processing unit. Such a memory configures is delineated by the dashed line 504 in FIG. 5.

The computer 500 may include additional storage (removable storage, nonremovable storage, or both) including, but not limited to, solid state devices or magnetically or optically recorded disks. Such additional storage is illustrated in FIG. 5 by removable storage 508 and non-removable storage 510. The various components in FIG. 5 are generally interconnected by an interconnection mechanism 530, such as one or more buses or switches or other electrical or optical connections allowing data and instructions to be passed among the components. The computer 500 may also include one or more communications connection(s) 512 that allow the computer to communicate with other devices over a communication medium.

Computer storage media and communication media are mutually exclusive categories of media.

A computer storage medium is any medium in which data can be stored in and retrieved from addressable physical storage locations by the computer. Computer storage media includes volatile and nonvolatile memory devices, and removable and non-removable storage devices. Memory 504, removable storage 508 and non-removable storage 510 are all examples of computer storage media. Some examples of computer storage media are DRAM, SRAM, and ROM devices, flash memory, solid state storage devices, or other electronic storage technology, CD-ROM, digital versatile disks (DVD), or other optically or magneto-optically recorded storage devices, or magnetic disk storage or other magnetic storage devices.

Communication media typically propagate a modulated data signal such as a carrier wave or other transport mechanism over or through a wired or wireless substance to transmit information, such as data, data structures, computer program code, program modules or other information, from one device to another device. The term "modulated data signal" means a signal that has one or more of its characteristics set or changed in such a manner as to encode information in the signal. A transmitting device changes its configuration or state to transform the signal generated for transport over the communication medium based on the information to be encoded. A receiving device changes its configuration or state in response to the signal to transform the signal back into the information, i.e., to decode the signal. By way of example, and not limitation, communication media includes wired media such as a wired network or direct-wired connection, such as electrical, optical, or electro-optical wired connections, and wireless media, which includes any non-wired communication media that allows propagation of signals, such as acoustic, electromagnetic, electrical, optical, infrared, radio frequency and other signals.

Communications connections 512 are devices, such as a network interface or radio transmitter, which access communication media to transmit data, or receive data, or both transmit and receive data, in signals propagated through the communication media to support communications with other devices. Example communications connections include, but are not limited to, a computer network interface device that provides a wired connection to a computer network, a wireless communication interface for wireless connection to a computer network, or a radio transmitter for telephonic communications over cellular telephone networks. A wired connection typically includes an electrical and mechanical interface to connect physically and electrically to the communication media. For example, a cellular connection, a Wi-Fi connection, a Bluetooth connection, an Ethernet connection, and yet other connections may be present in the computer.

The computer 500 may have various input device(s) 514 such as one or more various pointer (whether single-pointer or multi-pointer) devices, such as a mouse, tablet and pen, touchpad and other touch-based input devices, or stylus, one or more keypad or keyboard devices, one or more image input devices, such as still and motion cameras, one or more audio input devices, such as a microphone, or other devices, such as a push button device, a switch, a fader, a knob, an audio controller, or other mechanical device that produces a signal responsive to a user or machine input. Such input devices are well known in the art and need not be discussed at length here.

The computer may have various output device(s) 510, such as presentation devices, which present visual, audible, tactile or other forms of information to users, such as a display, speakers, printers, and so on, and controlled devices, such as equipment, robotics, machines, or other mechanical, electrical, optical or other devices. Such output devices are well known in the art and need not be discussed at length here.

In some implementations, one or more of the computer storage 508, 510, communication connection 512, output device 516 and input device 514 can be integrated within a housing of the computer. In some implementations, one or more of such components can be connected to the computer through an interface device in the computer. Such an interface device includes a communication connection, which connects the computer to a communication medium connected to the device, and a processing logic, which controls how the computer receives or transmits signals over the communication medium. The reference numbers 508, 510, 512, 514 and 516 can be understood to either indicate the interface for connection to a device or indicate the device itself, or both.

The operating system of the computer typically includes one or more computer programs, commonly called a driver, which respectively manages access to a resource, such as computer storage 508 and 510, a communication connection 512, an output device 516, or an input device 514. Such access generally includes managing inputs from and outputs to the device. In the case of communication connections, the operating system also may include one or more computer programs for implementing communication protocols used to communicate information between computers and devices through the communication connections 512.

Each component (which also may be called an “application”, a “module”, an “engine”, a “computational model”, a “generator”, a “processor” or the like), of a computer system such as described herein, and which operates on one or more computers, can be implemented as computer program code processed by the processing system(s) of one or more computers. Computer program code includes computer-executable instructions and/or computer-interpreted instructions, such as program modules, which instructions are processed by a processing system of a computer. Generally, such instructions define routines, programs, objects, components, data structures, and so on, that, when processed by a processing system, instruct the processing system to perform operations on data or configure the processor or computer to implement various components or data structures in computer storage. A data structure is defined in a computer program and specifies how data is organized in computer storage, such as in a memory device or a storage device, so that the data can be accessed, manipulated, and stored by a processing system of a computer.

It should be understood that the subject matter defined in the appended claims is not necessarily limited to the specific implementations described above. The specific implementations described above are disclosed as examples only.

What is claimed is:

1. In a system having a first delivery system, a second delivery system, and a subscriber device, wherein the subscriber device receives first media data from the first delivery system and is configured to present the first media data in synchronization with presentation of second audiovisual data from the second delivery system in an environment of the subscriber device, the system including:
an application executing on the subscriber device to capture an audio signal from a microphone responsive to sound present in the environment of the subscriber device; and
a component executing on a computing device having inputs to receive the captured audio signals from the application and reference audio data provided to the first delivery system by the second delivery system, the component being configured to compare the captured audio signal to the reference audio data to determine any delay between the sound present in the environment of the subscriber device and the reference audio data, the component further having an output providing the determined delay;
wherein the system causes presentation of the first media data to be delayed according to the determined delay to synchronize presentation of the first media data with presentation of the second audiovisual data.

2. The system of claim 1, wherein the component resides on the subscriber device.

3. The system of claim 2, wherein the application causes the first media data to be output to a presentation device based on the determined delay.

4. The system of claim 3, wherein the application causes the first media data to be rendered and presented based on the determined delay.

5. The system of claim 2, wherein the application causes the first media data to be rendered and presented based on the determined delay.

6. The system of claim 1, wherein the component resides on a computing device of the first delivery system.

7. The system of claim 4, wherein an edge device, having a connection with the subscriber device for delivery of the first media data to the subscriber device, delays transmission of the first media data to the subscriber device based on the determined delay.

8. The system of claim 1, wherein the component resides on an edge device having a connection with the subscriber device for delivery of the first media data to the subscriber device.

9. The system of claim 8, wherein the edge device delays transmission of the first media data to the subscriber device based on the determined delay.

10. The system of claim 1, wherein the first media data comprises a plurality of selectable media streams.

11. The system of claim 10, wherein each subscriber device includes a respective media player allowing a user to make a respective selection of one or more of the plurality of selectable media streams for presentation on the subscriber device.

12. In a system having a first delivery system, a second delivery system, and a plurality of subscriber devices, wherein each subscriber device in the plurality of subscriber devices receives a respective transmission of first media data from the first delivery system and is configured to present the first media data in synchronization with presentation of second audiovisual data from the second delivery system in a respective environment of the subscriber device, the system including:
a respective application, executing on each subscriber device, to capture an audio signal from a respective microphone responsive to sound present in the respective environment of the subscriber device; and
for each subscriber device, a respective component executing on a computing device having inputs to receive the captured audio signal from the respective application for the subscriber device and reference audio data provided to the first delivery system by the second delivery system, the respective component being configured to compare the captured audio signal from the respective application to the reference audio data to determine any respective delay between the sound present in the environment of the subscriber device and the reference audio data, the respective component further having an output providing the respective determined delay for the subscriber device;
wherein the first delivery system includes at least one edge device having respective connections established to transmit data to each subscriber device of the plurality of subscriber devices, wherein the at least one edge device includes a buffer for storing the first audiovisual data and a data transfer controller responsive to the respective determined delays for the plurality of subscriber devices to delay transmission of the first audiovisual data from the buffer to each subscriber device based on the respective determined delays for the subscriber devices.

13. The system of claim 12, wherein the first media data comprises a plurality of selectable media streams.

14. The system of claim 13, wherein each subscriber device includes a respective media player allowing a user to make a respective selection of one or more of the plurality of selectable media streams for presentation on the subscriber device.
